(19) United States
(12) Patent Application Publication
(10) Pub. No.: US 2019/0385392 A1
(43) Pub. Date: Dec. 19, 2019

(54) DIGITAL DOOR LOCK HAVING UNIQUE MASTER KEY AND METHOD OF OPERATING THE DIGITAL DOOR

(71) Applicant: SAMSUNG SDS CO., LTD., Seoul (KR)

(72) Inventors: Sung Bum CHO, Seoul (KR); Chol Han PARK, Seoul (KR); Jong Soo PARK, Seoul (KR)

(73) Assignee: SAMSUNG SDS CO., LTD., Seoul (KR)

(21) Appl. No.: 16/113,312

(22) Filed: Aug. 27, 2018

(30) Foreign Application Priority Data
Jun. 19, 2018 (KR) 10- 2018-0070486

(51) Int. Cl. G07C 9/00; H04W 12/04; H04W 12/06; H04L 9/08

(52) U.S. Cl. CPC G07C 9/00309; H04W 12/04; H04W 12/06; H04L 9/0894; G07C 2009/00317; H04L 2209/805; G07C 2009/00412; G07C 2009/00769; H04L 2209/16

(57) ABSTRACT

Provided is a digital door lock which can issue a master key, can be operated using a terminal having the master key and can be operated using a terminal having a slave key distributed by a user of the terminal having the master key, regardless of whether the digital door lock is connected to a network. The digital door lock includes: a storage unit which stores a master key unique to the digital door lock and recorded at the time of manufacturing the digital door lock; a wireless communication interface which provides a short-range wireless communication function; and a processor which controls the wireless communication interface to transmit the master key to a master control terminal directly connected through the wireless communication interface.

This application claims the benefit of Korean Patent Application No. 10-2018-0070486, filed on Jun. 19, 2018, in the Korean Intellectual Property Office, the disclosure of which is incorporated herein by reference in its entirety.

### BACKGROUND

### 1. Field

The inventive concept relates to a wireless communication device such as a digital door lock, and more particularly, to a wireless communication device that has a unique master key and is operated by transmitting or receiving the master key to or from a terminal device through short-range wireless communication.

### 2. Description of the Related Art

As a conventional method of limiting the authority to control a device, a lock may be installed on the device, and the device may be allowed to be controlled only when the lock is turned ON by a key inserted into the lock. However, this method has several disadvantages. For example, a physical key is easy to duplicate. In addition, to give another person the authority to control the device, the physical key must be actually provided to that person.

To solve these disadvantages, the lock and the key may be implemented in software. For example, there is provided a digital door lock developed to open a door when receiving previously registered key data from an external device such as a smartphone through short-range wireless communication. The short-range wireless communication refers to wireless communication operating at short distances. Examples of the short-range wireless communication include Bluetooth, Wi-Fi, EnOcean, radio frequency identification (RFID), and near-field communication (NFC).

Research is being conducted to improve user convenience in relation to the digital door lock introduced above. For example, a user having the master authority for the digital door lock may remotely control the digital door lock to perform a door opening operation. In addition, the user having the master authority may request a server to issue a one-time key for a visitor to a terminal of the visitor. These technologies for improving user convenience help overcome geographic limitations. However, since the technologies require the server connected to the digital door lock, they are useless when the digital door lock is not connected to the server. For example, when a master key of the digital door lock is issued, it is registered with the server in order for a key service such as issuing a visitor key for a user of a terminal which receives the master key. However, if home Internet is not installed due to home moving, even the issuance of the master key of the digital door lock is impossible.

In addition, there is a concern about the leakage of key data. When the key data for operating the digital door lock is leaked by hacking or the like, the digital door lock can be improperly operated using the leaked key data.

Therefore, it is required to provide a wireless communication device which can issue a key and can be operated using the key even in a state where a network is not connected to a digital door lock or an environment where a mobile communication network is not provided, and a method of operating the wireless communication device.

### SUMMARY

Aspects of the inventive concept provide a wireless communication device capable of issuing a master key to a master control terminal even in a situation where at least one of the wireless communication device and the master control terminal receiving the master key from the wireless communication device is not connected to an external network, and a method of operating the wireless communication device.

Aspects of the inventive concept also provide a security-robust wireless communication device capable of minimizing the risk of leakage of a master key even when transmitting the master key, which can be used to operate the wireless communication device, to an external terminal through short-range wireless communication and, even if the master key is leaked to the outside, not being operated by a terminal without legitimate key service software, and a method of operating the wireless communication device.

Aspects of the inventive concept also provide a wireless communication device which can be operated using a master key or a slave key even when not connected to an external network as long as the master key or the slave key is stored, and a method of operating the wireless communication device.

Aspects of the inventive concept also provide a wireless communication device which can be operated normally using a master key and a slave key even if disconnected from an external network after the master key is issued by the wireless communication device and the slave key is issued by a user receiving the master key in a state where the wireless communication device is connected to the external network, and a method of operating the wireless communication device.

However, aspects of the inventive concept are not restricted to the one set forth herein. The above and other aspects of the inventive concept will become more apparent to one of ordinary skill in the art to which the inventive concept pertains by referencing the detailed description of the inventive concept given below.

According to an aspect of the inventive concept, there is provided a digital door lock comprising: a storage unit which stores a master key unique to the digital door lock and recorded at the time of manufacturing the digital door lock; a wireless communication interface which provides a short-range wireless communication function; and a processor which controls the wireless communication interface to transmit the master key to a master control terminal directly connected through the wireless communication interface, wherein the processor compares a master key included in a control request with the master key stored in the storage unit when receiving the control request from the master control terminal through the wireless communication interface, obtains verification data and controls the wireless communication interface to transmit the verification data to the master control terminal when determining that authentication has passed as a result of the comparison, and generates a control signal for performing an operation according to the control request when receiving the verification data from the master control terminal through the wireless communication interface.

According to another aspect of the inventive concept, there is provided a digital door lock comprising: a storage unit which stores a master key unique to the digital door lock and recorded at the time of manufacturing the digital door lock; a wireless communication interface which provides a short-range wireless communication function; and a processor which controls the wireless communication interface to transmit the master key to a master control terminal directly connected through the wireless communication interface, wherein the processor compares a master key included in a control request with the master key stored in the storage unit when receiving the control request from the master control terminal through the wireless communication interface, generates first random data when determining that authentication has passed as a result of the comparison of the master key included in a control request with the master key stored in the storage unit, compares whether second random data received from the master control terminal through the wireless communication interface matches the generated first random data, and generates a control signal for performing an operation according to the control request when the first random data and the second random data correspond to each other as a result of the comparison of the first random data with the second random data.

According to another aspect of the inventive concept, there is provided a method of operating a digital door lock, the method comprising: establishing a first direct connection between the digital door lock and a master control terminal through short-range wireless communication; by using the digital door lock, transmitting a master key, which is unique to the digital door lock and stored at the time of manufacturing the digital door lock, to the master control terminal directly connected to the digital door lock through the first direct connection; storing the master key by using the master control terminal; establishing a second direct connection between the digital door lock and the master control terminal through the short-range wireless communication; transmitting a control request to the digital door lock through the second direct connection by using the master control terminal; by using the digital door lock, comparing a master key included in the control request with the master key stored at the time of manufacturing the digital door lock, obtaining verification data when determining that authentication has passed as a result of the comparison, and transmitting the encrypted verification data to the master control terminal through the second direct connection; by using the master control terminal, decrypting the received timestamp and transmitting the encrypted verification data to the digital door lock through the second direct connection; and by using the digital door lock, decrypting the encrypted verification data received from the master control terminal and performing an operation according to the control request when the decrypted verification data matches the obtained verification data.

According to another aspect of the inventive concept, there is provided a digital door lock comprising: a storage unit which stores a master key unique to the digital door lock and recorded at the time of manufacturing the digital door lock; a wireless communication interface which provides a short-range wireless communication function; an Internet interface which is connected to a server through the Internet; and a processor which controls the Internet interface to transmit the master key to the server through the Internet, wherein the processor compares a master key included in a control request with the master key stored in the storage unit when receiving the control request from a master control terminal, which receives and stores the master key from the server, through the wireless communication interface, obtains verification data and controls the wireless communication interface to transmit the verification data to the master control terminal when determining that authentication has passed as a result of the comparison, and generates a control signal for performing an operation according to the control request when receiving the verification data from the master control terminal through the wireless communication interface, wherein the wireless communication interface receives the control request in a state where Internet connection through the Internet interface is interrupted.

### BRIEF DESCRIPTION OF THE DRAWINGS

These and/or other aspects will become apparent and more readily appreciated from the following description of the embodiments, taken in conjunction with the accompanying drawings in which:

FIGS. 1 and 2 illustrate the configuration of a wireless communication device operating system according to an embodiment;

FIGS. 3 through 5 are block diagrams of wireless communication devices according to embodiments;

FIGS. 6 through 8B are signal flowcharts illustrating a method of operating a wireless communication device according to an embodiment;

FIGS. 9 and 10 are other block diagrams of the wireless communication devices described with reference to FIGS. 3 through 5;

FIGS. 11 through 13B are other signal flowcharts further illustrating the method of operating a wireless communication device described with reference to FIGS. 6 through 8; and

FIG. 14 is a signal flowchart illustrating a method of operating a wireless communication device according to an embodiment.

### DETAILED DESCRIPTION

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

It will be understood that the terms “comprise” and/or “comprising” when used herein, specify some stated components, steps, operations and/or elements, but do not preclude the presence or addition of one or more other components, steps, operations and/or elements.

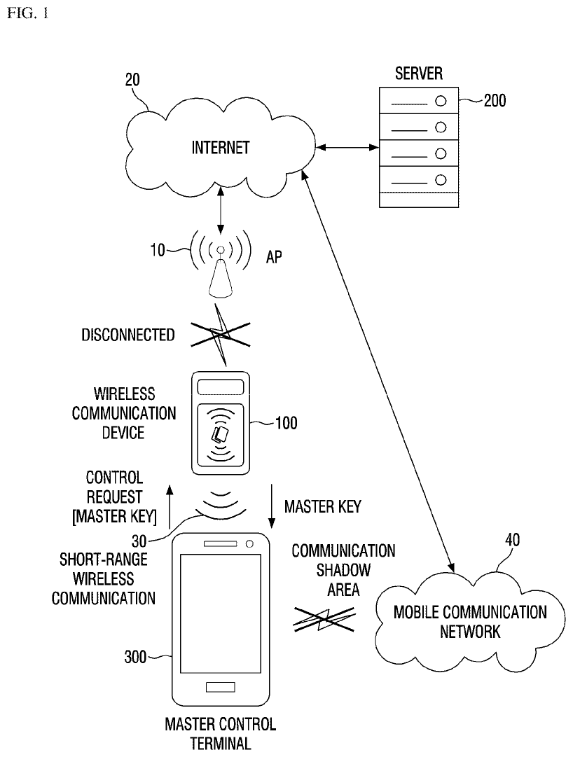

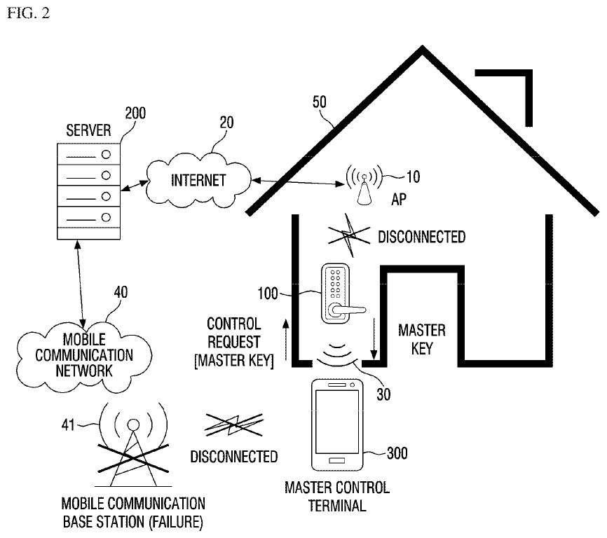

The configuration and operation of a wireless communication device operating system according to an embodiment of the inventive concept will now be described with reference to FIGS. 1 and 2. The wireless communication device operating system according to the current embodiment includes a wireless communication device 100 and a master control terminal 300.

The master control terminal 300 is a terminal of a user having the original authority to operate the wireless communication device 100, such as the owner of the wireless communication device 100. The master control terminal 300 has a mobile communication interface connectable to a mobile communication network 40 and may be a mobile terminal such as a smartphone, a tablet, a smart watch, or a notebook. The wireless communication device 100 has a short-range wireless communication function. The short-range wireless communication is a technology that enables devices to exchange information at short ranges without contact with each other, such as Bluetooth, Wi-Fi, EnOcean, radio frequency identification (RFID), near-field communication (NFC), or ZigBee.

The wireless communication device 100 may be, for example, a digital door lock.

The wireless communication device 100 is ‘directly’ connected to the master control terminal 300 through a short-range wireless communication connection 30. When the wireless communication device 100 is ‘directly connected’ to the master control terminal 300, it means that the wireless communication device 100 is connected to the master control terminal 300 without via another device. The wireless communication device 100 may be connected to the master control terminal 300 through NFC connection. The frequency of the NFC connection is 13.56 MHz, which is advantageous in terms of compatibility because all the mobile terminals in the world use the same frequency.

In addition, when transmitting or receiving data to or from the master control terminal 300 through the short-range wireless communication connection 30, the wireless communication device 100 increases security by transmitting or receiving encrypted data instead of transmitting or receiving data as it is.

The wireless communication device 100 may also have a function of wirelessly connecting to a network device such as an access point (AP) 10 so as to be connected to a server 200 through the Internet 20.

In a state where the wireless communication device 100 is connected to the server 200 and the master control terminal 300 is also connected to the server 200 through the mobile communication network 40, the master control terminal 300 provides a key service including all functions related to the operation of the wireless communication device 100 under the involvement of the server 200. For example, when an acquaintance is supposed to visit during absence, a user (hereinafter, referred to as a ‘master user’) of the master control terminal 300 may request the server 200 to issue a slave key to the acquaintance's terminal, access the server 200 to check operation records of the wireless communication device 100, or request the server 200 to delete the issued slave key. In addition, when the wireless communication device 100 in an initialized state is first connected to the server 200, it may transmit a master key already stored at the time of manufacture to the server 200. The server 200 may store the master key and transmit the stored master key to the master control terminal 300 when the master user registers with the server 200 and is authenticated as the owner of the wireless communication device 100.

Since the master key is stored in the wireless communication device 100 at the time of manufacturing the wireless communication device 100, the wireless communication device operating system according to the current embodiment can issue the master key to the master control terminal 300 even when the wireless communication device 100 is not connected to the server 200. That is, since the wireless communication device 100 stores the master key even in a factory-initialized state, once the wireless communication device 100 is installed and powered ON, the master key can be transmitted to the master control terminal 300 through the short-range wireless communication connection 30.

The master key is unique to the wireless communication device 100. That is, all wireless communication devices 100 have different master keys. When receiving a key from an external terminal through short-range wireless communication, the wireless communication device 100 checks whether the received key is identical to the master key of the wireless communication device 100 and performs an operation requested by the external terminal if the received key is identical to the master key. This is why all wireless communication devices 100 must have their unique master keys.

In an embodiment, the master key may be generated using both an identifier of a processor included in the wireless communication device 100 and a manufacturer identifier unique to the manufacturer of the wireless communication device 100. The identifier of the processor may be a serial number of the processor, and the manufacturer identifier may be an application identifier according to ISO-7816-5. The master key may be generated using serial numbers of all the processors (including a microcontroller unit (MCU)) provided in the wireless communication device 100 and an application identifier assigned to the manufacturer of the wireless communication device 100. The master key may be digital data generated as a result of encrypting the serial numbers of all the processors (including the MCU) provided in the wireless communication device 100 and the application identifier assigned to the manufacturer of the wireless communication device 100.

Like the wireless communication device 100, the master control terminal 300 may receive the master key through the short-ranged wireless communication connection 30 even in a state where its connection to the server 200 through the mobile communication network 40 is interrupted. That is, the wireless communication device operating system according to the current embodiment can normally issue the master key to the master control terminal 300 even in an environment in which the Internet is not connected and in a communication shadow area of a mobile communication network. The master control terminal 300 may store the issued master key in an internal storage to which security technology has been applied, and the master user may be able to operate the wireless communication device 100 only by bringing the master control terminal 300 into contact with the wireless communication device 100. The master control terminal 300 may encrypt and store the master key using white box cryptography (WBC) technology.

The master control terminal 300 may be equipped with an application for controlling the wireless communication device 100. Once the short-range wireless communication 30 is established between the master control terminal 300 and the wireless communication device 100, the master control terminal 300 transmits a control request including the master key stored in the master control terminal 300 to the wireless communication device 100 through the short-range wireless communication connection 30.

The control request may be made under the control of the application or may be automatically made in response to the short-range wireless communication connection 30 being established according to the configuration result of the application.

The master control terminal 300 may transmit or receive the master key to or from the wireless communication device 100 using host card emulation (HCE) technology.

The wireless communication device 100 may be an access control device used to enter a specific space such as a house, an office or a warehouse, may be a starting control device used to utilize a transportation device such as a car or a motorcycle, or may be a device that must be unlocked to use various devices other than the transportation device.

FIG. 2 illustrates a case where the wireless communication device 100 is a digital door lock installed in a house 50. As described above, even if the digital door lock 100 cannot be connected to the server 200, for example, even if the AP 10 fails at a time when the owner of the house 50 installs the digital door lock or even if there is a problem with the Internet connection 20 installed in the house 50, the owner of the house 50 can still receive and store the master key by simply bringing the master control terminal 300 into contact with the digital door lock. In addition, even if the master control terminal 300 cannot be connected to the mobile communication network 40 at the time of receiving the master key due to a failure in a mobile communication base station 41 covering the house 50, the master control terminal 300 can still receive the master key without any problem. Also, the owner of the house 50 can control the digital door lock to perform a door opening operation by simply bringing his or her master control terminal 300 into contact with the digital door lock.

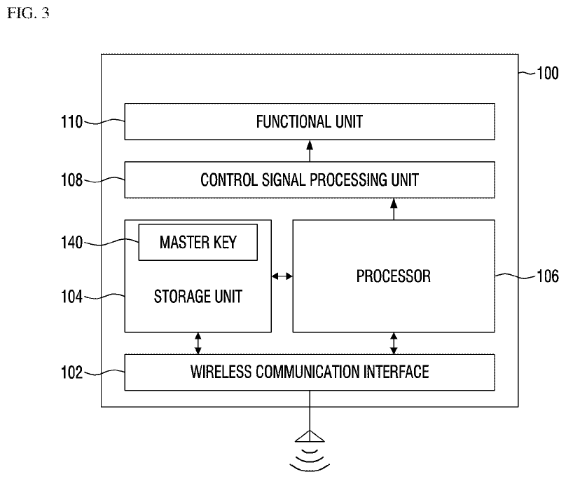

The configuration and operation of wireless communication devices 100 according to embodiments of the inventive concept will now be described with reference to FIGS. 3 through 5. Referring to FIG. 3, the wireless communication device 100 according to the current embodiment includes a storage unit 104, a wireless communication interface 102, and a processor 106.

The storage unit 104 stores a master key 140 stored at the time of manufacturing the wireless communication device 100. At least some storage areas of the storage unit 104 may store data encrypted using the WBC technology. The storage unit 104 may store the master key 140 using the WBC technology.

The wireless communication device 100 may further include a control signal processing unit 108 which processes a control signal generated by the processor 106 and provides the processed control signal to a functional unit 110. The functional unit 110 may be a physical mechanism or a digital module that performs an unlocking operation in response to a signal received from the control signal processing unit 108. For example, if the wireless communication device 100 is a digital door lock, the functional unit 110 is a lock that operates upon receipt of an electrical signal for switching to a lock/unlock state. If the wireless communication device 100 is a wireless locking device installed in a vehicle, the functional unit 110 may be a module that generates an electrical signal for controlling door opening/locking of the vehicle.

The processor 106 controls the wireless communication interface 102 to transmit the master key 140 to a master control terminal directly connected through the wireless communication interface 102. Here, the processor 106 may control the wireless communication interface 102 to transmit the master key 140 only when the transmission of the master key 140 is allowed.

For example, the wireless communication device 100 may issue only one master key. In this case, the processor 106 may check the value of a flag initialized to a first value (e.g., FALSE; indicating that the master key has not been issued yet) at the time of manufacturing the wireless communication device 100, transmit the master key only when the value of the flag is the first value, and change the value of the flag to a second value (e.g., TRUE: indicating that the master key has not been issued yet) different from the first value when transmitting the master key. The flag may be stored in the storage unit 104 or may be stored in a storage (not illustrated) other than the storage unit 104.

For example, the wireless communication device 100 may issue only a number of master keys preset at the time of manufacturing the wireless communication device 100. In this case, the processor 106 may check a key issuance counter that is initialized at the time of manufacturing the wireless communication device 100 and incremented by one upon transmission of the master key 140 and may control the wireless communication interface 102 to transmit the master key 140 only when the value of the key issuance counter is less than a preset threshold value. The key issuance counter may be stored in the storage unit 104 or may be stored in a storage (not illustrated) other than the storage unit 104.

In addition, when receiving a control request from the master control terminal through the wireless communication interface 102, the processor 106 determines whether to perform an operation according to the control request.

The processor 106 may, for a first time, compare a master key included in the control request with the master key 140 stored in the storage unit 104 and determine whether to perform the operation according to the control request using the result of the first comparison. For example, if the master key included in the control request is identical to the master key 140 stored in the storage unit 104, the processor 106 may generate a control signal for performing the operation according to the control request and provide the control signal to the control signal processing unit 108.

Even if the master key 140 is leaked by hacking, the processor 106 may increase security by performing an additional authentication procedure to prevent the wireless communication device 100 from being operated using only the master key 140.

As an example of the additional authentication procedure, the wireless communication device 100 may obtain a timestamp after determining, as a result of the first comparison, that the master key included in the control request is identical to the master key 140 stored in the storage unit 104 and transmit the obtained timestamp to the master control terminal through the wireless communication interface 102. Then, when a timestamp value is received from the master control terminal through the wireless communication interface 102, the wireless communication device 100 may allow itself to be operated only if the received timestamp value is the same as the value of the obtained timestamp. Here, the wireless communication device 100 and the master control terminal may transmit or receive the timestamp and the master key to or from each other after performing string concatenation on the timestamp and the master key. For security enhancement, a string of the master key and the timestamp concatenated may be transmitted or received after being encoded or encrypted in a predetermined manner.

If the master key is leaked by hacking, it may be possible to pass the primary authentication through the master key comparison, but may not be possible to pass the secondary authentication through the timestamp comparison. This is because the timestamp value is not a fixed value but is a value that changes every time. Further, since the timestamp value is received after being encoded or encrypted in a predetermined manner, it is almost impossible to pass the secondary authentication by finding out the encoding or encryption method.

In addition, as another example of the additional authentication procedure, two pieces of random data generated respectively by the wireless communication device 100 and the master control terminal may be compared to increase security. More specifically, the processor 106 may generate first random data if determining that the authentication has passed as a result of the first comparison, compare, for a second time, whether second random data received from the master control terminal through the wireless communication interface 102 corresponds to the first random data, generate a control signal for performing the operation according to the control request if the first random data and the second random data correspond to each other as a result of the second comparison, and provide the control signal to the control signal processing unit 108.

Here, the processor 106 may transmit seed data used to generate the first random data to the master control terminal through the wireless communication interface 102. When determining that the authentication has passed as a result of the first comparison, the processor 106 may obtain the seed data immediately, transmit the seed data to the master control terminal, and then generate the first random data using the seed data. Alternatively, when determining that the authentication has passed as a result of the first comparison, the processor 106 may obtain seed data immediately, generate the first random data using the seed data, and then transmit the seed data to the master control terminal.

The seed data may be a timestamp obtained at a point in time between a time when it is determined that the authentication has passed as a result of the first comparison and a time when a routine for generating the first random data is called.

A random data generation routine executed by the processor 106 of the wireless communication device 100 and a random data generation routine executed by a processor of the master control terminal are the same. Therefore, there may be found a corresponding relationship between the first random data and the second random data generated by the same random data generation routine using the same seed data.

If the master key is leaked by hacking, it may be possible to pass the primary authentication through the master key comparison, but may not be possible to pass the secondary authentication through the random data comparison. This is because both the random data generation routine used by the wireless communication device 100 and the seed data used by the wireless communication device 100 to generate the first random data must be identified to pass the secondary authentication, which is almost impossible.

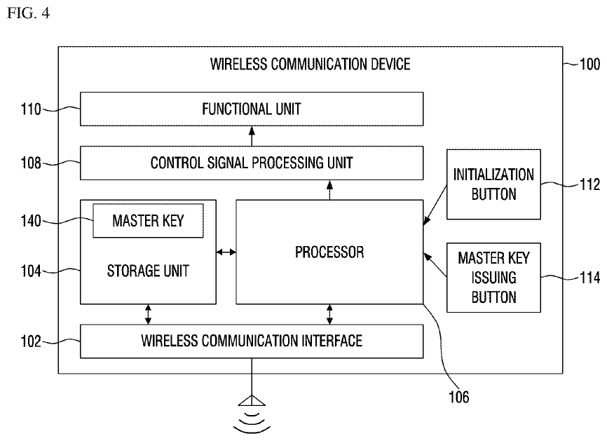

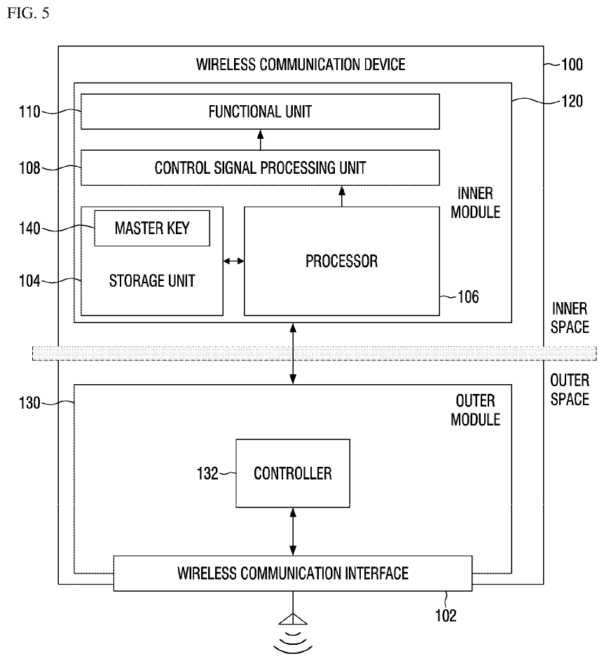

The wireless communication device 100 according to the current embodiment may further include at least one of an initialization button 112 and a master key issuing button 114 as illustrated in FIG. 4.

The wireless communication device 100 activates the wireless communication interface 102 when the master key issuing button 114 is pressed and transmits the master key 140 when the master control terminal is connected through the wireless communication interface 102.

In an embodiment, the processor 106 may control the wireless communication interface 102 to transmit the master key 140 in response to NFC tagging of the master control terminal through the wireless communication interface 102. For example, the processor 106 may control the wireless communication interface 102 to transmit the master key 140 in response to the NFC tagging performed in a state where the wireless communication device 100 has been initialized or in a state where the master key 140 can be issued. Here, a user can easily get the master key 140 issued by simply NFC-tagging his/her mobile terminal to his/her wireless communication device 100.

When the initialization button 112 is pressed in a state where the master control terminal is connected through the wireless communication interface 102, the wireless communication device 100 transmits a master key deletion request to the master control terminal. Upon receiving the master key deletion request, the master control terminal deletes a stored master key. Since the master control terminal may store master keys of a plurality of wireless communication devices 100, the master key deletion request may include the master key 140 of the wireless communication device 100. In this case, the master control terminal may delete the master key 140 included in the master key deletion request. After deleting the master key 140 successfully, the master control terminal may transmit an acknowledgement (Ack) signal as a response to the master key deletion request. When receiving the Ack signal, the wireless communication device 100 updates data indicating master key issuance status. For example, in a case where the wireless communication device 100 issues only one master key, the data indicating the master key issuance status will be updated to a value indicating that the master key has not been issued. In a case where the wireless communication device 100 issues a predetermined number of master keys, the number of master keys issued will be reduced by one in the data indicating the master key issuance status.

If the wireless communication device 100 is a device (e.g., a digital door lock) that must be unlocked to enter a specific space, the risk that the master key will be leaked may be further reduced by structuring the wireless communication device 100 as illustrated in FIG. 5. Referring to FIG. 5, a wireless communication device 100 according to the current embodiment may include an inner module 120 installed in an inner space of the specific space and an outer module 130 installed in an outer space of the specific space. The inner module 120 and the outer module 130 may exchange data using a wired or wireless communication method.

Since the outer space can be accessed by anyone, if a master key 140 is stored in the outer module 130, the risk of leakage of the master key 140 will be increased. The wireless communication device 100 according to the current embodiment minimizes the risk of leakage of the master key 140 by having a storage unit 104 that stores the master key 140 in the inner module 120 installed in the safe inner space. In the outer module 130, an antenna of a wireless communication interface 102 and a controller 132 of the wireless communication interface 102 are provided. This is because it is through the outer module 130 that residents, visitors, etc. in the outer space can be in close contact with the wireless communication device 100.

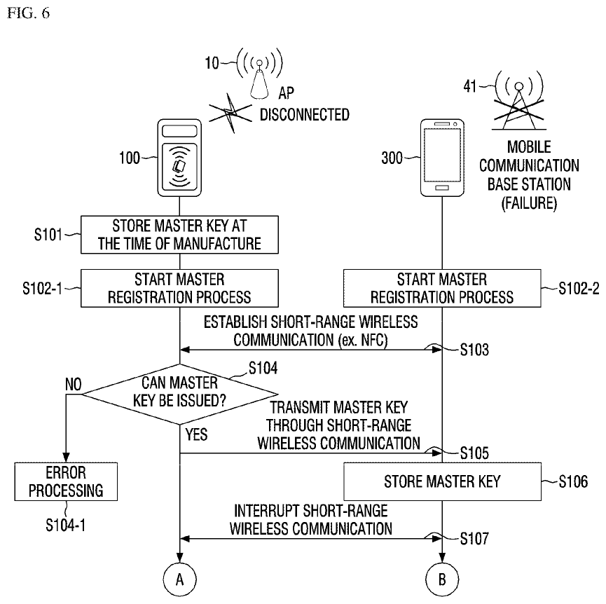

A method of operating a wireless communication device according to an embodiment of the inventive concept will now be described with reference to FIGS. 6 through 8B. The method according to the current embodiment may be performed, for example, by the wireless communication devices 100 described with reference to FIGS. 3 through 5 and the master control terminal 300 described with reference to FIGS. 1 through 5.

For a clearer understanding of the effect of the current embodiment, it is assumed that a wireless communication device 100 is disconnected from an AP 10 and a master control terminal 300 is also disconnected from an external network due to a failure of a mobile communication base station 41. FIG. 6 illustrates an operation in which the wireless communication device 100 issues a master key to the master control terminal 300 in a state where both the wireless communication device 100 and the master control terminal 300 are disconnected from a server (not illustrated).

A master key unique to the wireless communication device 100 is recorded in a storage unit of the wireless communication device 100 at the time of manufacturing the wireless communication device 100 (operation S101). A master registration process is started by, for example, pressing a master key issuing button provided in the wireless communication device 100 (operation S102-1). The master registration process is also started in the master control terminal 300 by, for example, operating an application installed in the master control terminal 300 (operation S102-2). Unlike in FIG. 6, in some embodiments, master key issuance is possible even if the master registration process is not started in at least one of the wireless communication device 100 and the master control terminal 300.

Next, when a short-range wireless communication connection is established between the wireless communication device 100 and the master control terminal 300 (operation S103), the wireless communication device 100 checks whether a master key can be issued (operation S104). If the master key cannot be issued, an error message is output (operation S104-1). If the master key can be issued, it is transmitted through the short-range wireless communication connection (operation S105). Some embodiments related to the checking of whether the master key can be issued (operation S104) have already been described above. The master control terminal 300 receives and stores the master key (operation S106). The master control terminal 300 may encrypt and store the master key using the WBC technology as described above.

Next, a user of the master control terminal 300 moves the master control terminal 300 away from the wireless communication device 100, thereby naturally interrupting the short-range wireless communication (operation S107). As described above, the method according to the current embodiment enables the master key to be issued without any problem even when the wireless communication device 100 is not connected to the server.

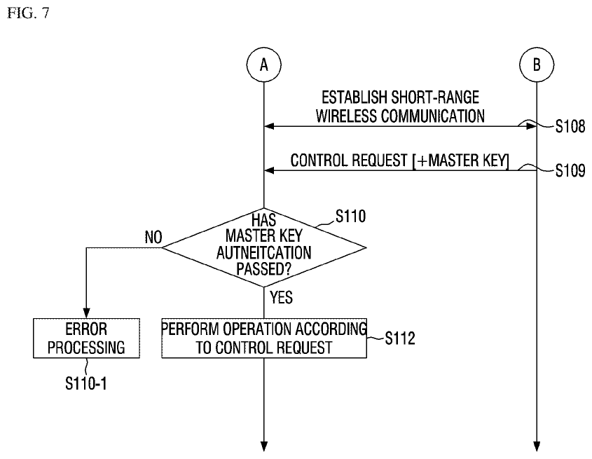

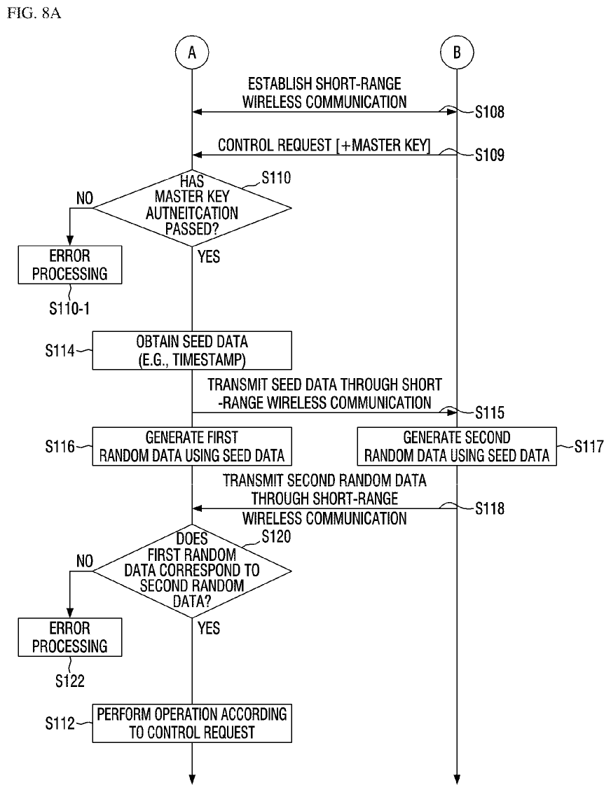

FIG. 7 is a diagram for explaining a method of operating the wireless communication device 100 using the master key stored in the master control terminal 300. Referring to FIG. 7, when the user of the master control terminal 300 brings the master control terminal 300 close to the wireless communication device 100, the short-range wireless communication is re-established (operation S108). When the master control terminal 300 transmits a control request including the master key to the wireless communication device 100 (operation S109), the wireless communication device 100 performs master key authentication by determining whether the stored master key matches the master key included in the control request. The control request may also include an identifier of an operation provided by the wireless communication device 100. If the master key authentication passes (operation S110), the wireless communication device 100 performs the operation according to the control request by referring to the identifier of the operation (operation S112). If the master key authentication fails (operation S110-1), the wireless communication device 100 outputs an error message.

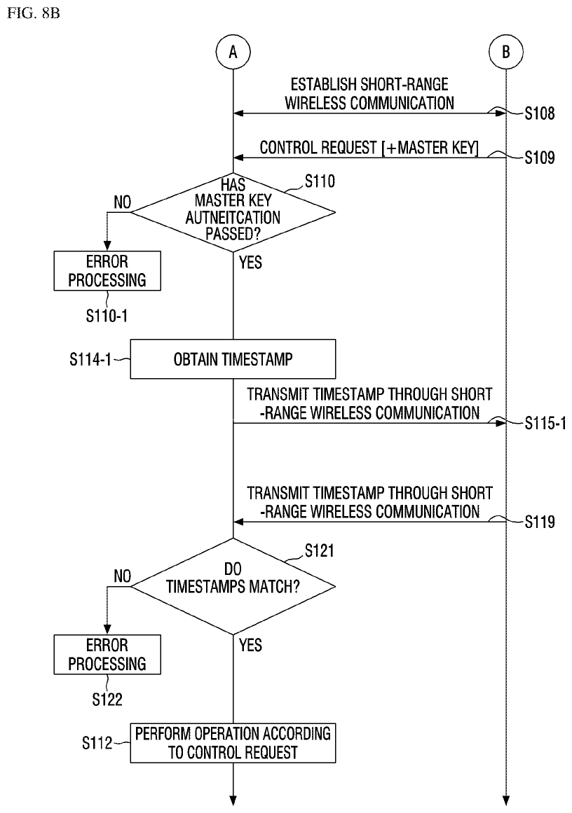

As already described above, a security-robust method of operating a wireless communication device can be provided by performing not only the master key authentication but also an additional authentication procedure. This will be described with reference to FIGS. 8A and 8B.

FIG. 8A is a diagram for explaining an additional authentication method in which the wireless communication device 100 and the master control terminal 300 generate respective random data and the wireless communication device 100 compares whether the random data generated by the master control terminal 300 matches the random data generated by the wireless communication device 100. The method will now be described with reference to FIG. 8A.

When the user of the master control terminal 300 brings the master control terminal 300 close to the wireless communication device 100, the short-range wireless communication is re-established (operation S108). When the master control terminal 300 transmits a control request including the master key to the wireless communication device 100 (operation S109), the wireless communication device 100 performs master key authentication by determining whether the stored master key matches the master key stored in the control request.

If the master key authentication passes (operation S110), the wireless communication device 100 obtains seed data (operation S114) and transmits the obtained seed data (operation S115). The seed data may be, for example, a timestamp or random data obtained between a time when it is determined that the master key authentication has passed (S110) and a time when the seed data is transmitted. The wireless communication device 100 generates first random data by inputting the obtained seed data to first random number generation logic (operation S116). The master control terminal 300 generates second random data by inputting the received seed data to the first random number generation logic (operation S117) and transmits the second random data to the wireless communication device 100 (operation S118).

The wireless communication device 100 determines whether the first random data and the second random data correspond to each other (operation S120). If the first random data and the second random data correspond to each other, the wireless communication device 100 performs an operation according to the control request of the master control terminal 300 (operation S112). If not, the wireless communication device 100 outputs an error message (operation S122).

Next, a description will be given with reference to FIG. 8B. FIG. 8B is a diagram for explaining a method of additionally verifying whether a master key processing related application installed in the master control terminal 300 is a fabricated application by additionally verifying whether the master control terminal 300 can return a timestamp generated by the wireless communication device 100 as it is.

When the user of the master control terminal 300 brings the master control terminal 300 close to the wireless communication device 100, the short-range wireless communication is re-established (operation S108). When the master control terminal 300 transmits a control request including the master key to the wireless communication device 100 (operation S109), the wireless communication device 100 performs master key authentication by determining whether the stored master key matches the master key stored in the control request.

If the master key authentication passes (operation S110), the wireless communication device 100 obtains a timestamp (operation S114-1) and transmits the obtained timestamp (operation S115-1). The wireless communication device 100 may transmit the timestamp by transmitting a master key generated by string concatenation of the master key and the timestamp to the master control terminal 300. The generated master key always has a different value as long as the time when the primary authentication passes is different. For security enhancement, the wireless communication device 100 may additionally encode or encrypt the generated master key and transmit the encoded or encrypted master key to the master control terminal 300. A normal master key processing related application installed in the master control terminal 300 may be implemented to decode or decrypt the generated master key according to the method in which the generated master key is encoded or encrypted, and the leakage of the encoding or encryption method of the generated master key may be prevented by code obfuscation or reverse engineering preventing technology. Therefore, even if software implemented to use a leaked master key is utilized, it will not be possible to pass the additional verification using the timestamp. In some embodiments, the timestamp may be replaced with random data obtained at the time when the master key authentication passes (operation S110). That is, in the current embodiment, when the master key authentication passes (operation S110), the wireless communication device 100 may obtain verification data, transmit the obtained verification data to the master control terminal 300, and additionally authenticate whether the master control terminal 300 can return the verification data as it is.

The wireless communication device 100 determines whether a timestamp received through the short-range wireless communication (operation S119) matches the timestamp obtained by the wireless communication device 100 (operation S114-1) (operation S121). If the received timestamp matches the obtained timestamp, the wireless communication device 100 performs an operation according to the control request of the master control terminal 300 (operation S112). If not, the wireless communication device 100 may output an error message (operation S122). That is, it is also possible to verify that the master key processing related application installed in the master control terminal 300 is not a fabricated application through the verification using the time stamp.

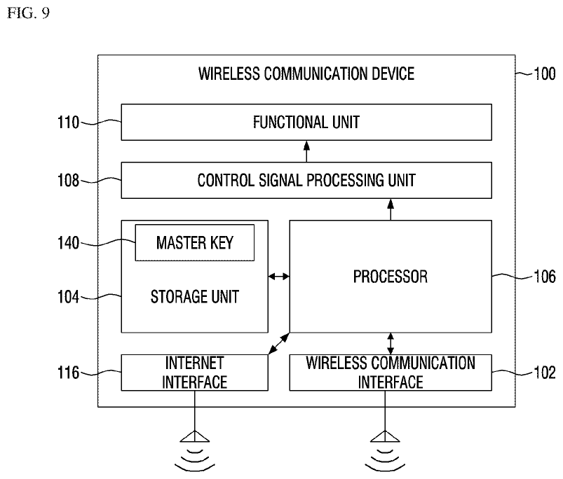

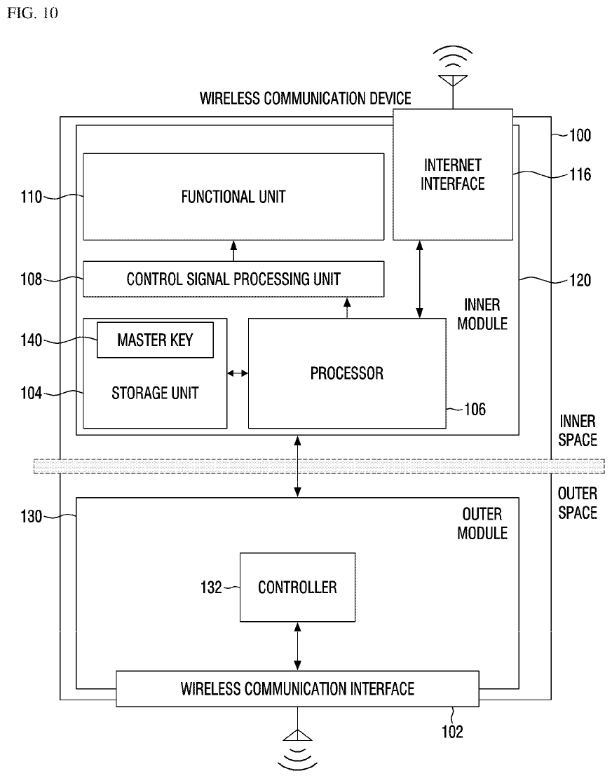

The wireless communication devices 100 described with reference to FIGS. 3 through 5 may additionally have an Internet connection function. The configuration of wireless communication devices connectable to the Internet will now be described with reference to FIGS. 9 and 10. FIG. 9 illustrates the configuration of the wireless communication device 100 of FIG. 3 which further includes an Internet interface 116 for providing Internet connection. FIG. 10 illustrates the configuration of the wireless communication device 100 of FIG. 5 which further includes an Internet interface 116 for providing Internet connection in the inner module 120. Since network equipment such as an AP for providing wireless Internet connection is mostly located in the inner space, it can be understood that the Internet interface 116 is also provided in the inner module 120.

When the wireless communication device 100 is connected to a server 200, it can also be operated using a slave key distributed at the request of a user of a master control terminal. In addition, the wireless communication device 100 does not need be continuously connected to the server 200 so as to be operated using the slave key. The connection between the wireless communication device 100 and the server 200 can be interrupted after the wireless communication device 100 stores the slave key and expiry information of the slave key received from the server 200.

A storage unit 104 of the wireless communication device 100 performing the above operation stores a slave key and expiry information of the slave key received from the server 200 through the Internet interface 116. In addition, when a control request is received from a slave control terminal directly connected through the wireless communication interface 102, a processor 106 determines whether a slave key included in the control request of the slave control terminal is stored in the storage unit 104 and generates a control signal for performing an operation according to the control request of the slave control terminal based on the determination result. Here, the slave control terminal is a terminal not connected to an external network, and the Internet interface 116 is not connected to the server 200 at the time of receiving the control request from the slave control terminal. If determining that the slave key is stored in the storage unit 104, the processor 106 may generate first random data and generate a control signal for performing the operation according to the control request of the slave control terminal if second random data received from the slave control terminal through the wireless communication interface 102 corresponds to the generated first random data.

The slave key and the expiry information of the slave key may be transmitted by the server 200 in response to a slave key distribution request received from the master control terminal. That is, the slave key may be instantly distributed in response to the slave key distribution request of the master control terminal. As a result, even when the wireless communication device 100 is disconnected from the server 200, it can still be operated using the slave key

In an embodiment, if determining that the slave key is stored in the storage unit 104, the processor 106 determines whether the slave key is valid based on the expiry information of the slave key and generates a control signal for performing the operation according to the control request based on the determination result. That is, the wireless communication device 100 may determine whether the slave key is valid at the very moment when receiving the control request using the slave key.

In an embodiment, the processor 106 may delete an expired slave key from among slave keys stored in the storage unit 104 based on the expiry information. That is, the wireless communication device 100 may delete expired slave keys periodically or non-periodically even if a control request using a slave key is not received.

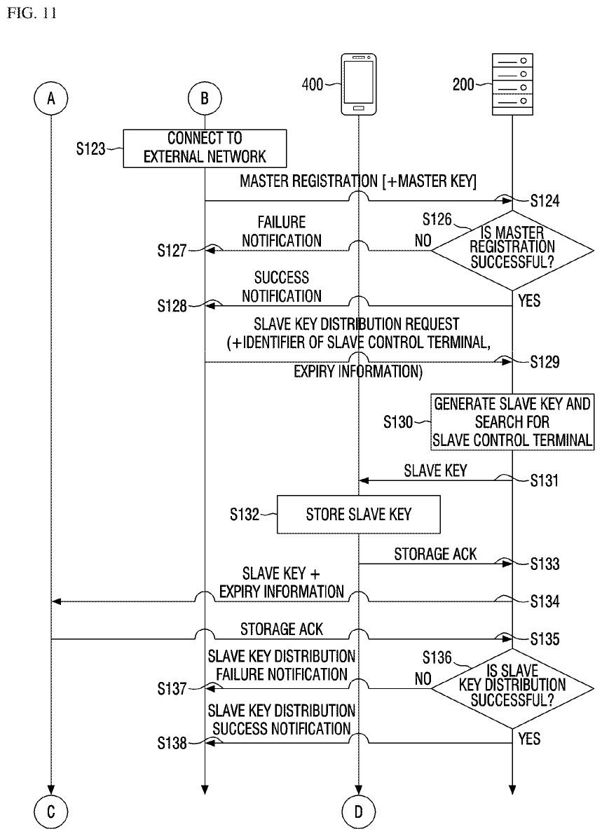

FIGS. 11 through 13B are other signal flowcharts further illustrating the method of operating a wireless communication device described with reference to FIGS. 6 through 8. Until now, embodiments in which only a master control terminal operates a wireless communication device have been described. FIGS. 11 through 13B are diagrams for explaining embodiments in which other users designated by a user of the master control terminal can operate the wireless communication device.

When only the master control terminal operates the wireless communication device, not all of the master control terminal and the wireless communication device need to be connected to a server. However, in order for another user designated by the user of the master control terminal to operate the wireless communication device using his or her terminal (hereinafter, referred to as a ‘slave control terminal’), all of the wireless communication device, the master control terminal and the slave control terminal need to be connected to the server even for a while. The master control terminal should be connected to the server in order to transmit a slave key distribution request to the server, the slave control terminal should be connected to the server in order to receive a slave key, and the wireless communication device should be connected to the server in order to receive the slave key and expiry information of the slave key. However, the wireless communication device, the master control terminal and the slave control terminal do not need to be connected to the server at the same time. In addition, the master control terminal, the slave control terminal, and the wireless communication device can be disconnected from the server after they are all connected to the server.

Specifically, referring to FIG. 11, when a master control terminal 300 is connected to a server 200 through an external network (operation S123), it registers a master key, which was issued and stored when the master control terminal 300 was not connected to the server 200, with the server 200 (operation S124). The server 200 determines whether the master key registration is successful by verifying whether the master key received from the master control terminal 300 has been previously registered or, if a plurality of master keys are set to be registered, verifying whether the number of times that the master key is registered is less than a threshold value (operation S126). As a result, the server 200 transmits a master registration success notification (operation S128) or a failure notification (operation S127) to the master control terminal 300.

The master control terminal 300 generates a slave key distribution request using information input by a user to an application and transmits the slave key distribution request to the server 200 (operation S129). The slave key distribution request includes an identifier of a slave control terminal or an ID of a user of the slave control terminal and expiry information of the slave key. The expiry information may include at least some of for example, information about the allowable number of times of operation, information about the allowable operation period, and information about an allowable operation.

The server 200 receives the slave key distribution request, generates a slave key to be transmitted to each slave control terminal, and searches for a slave control terminal to which the slave key is to be transmitted (operation S130). The generated slave key is different from the master key. The generated slave key may be the master key added with data. In an embodiment, the subject of the slave key generation may be the master control terminal 300, not the server 200.

The server 200 transmits the generated slave key to a slave control terminal 400 (operation S131). The slave control terminal 400 stores the received slave key (operation S132) and transmits an Ack signal as the storage result (operation S133). In addition, the server 200 transmits the slave key and expiry information of the slave key to a wireless communication device 100 (operation S134). The wireless communication device 100 stores the slave key and the expiry information of the slave key and transmits an Ack signal as the storage result (operation S135). The server 200 determines whether the slave key has been normally transmitted to the slave control terminal 400 and the wireless communication device 100 (operation S136) and transmits the determination result to the master control terminal 300 (operations S137 and S138) to inform the user of the master control terminal 300 about the slave key distribution result.

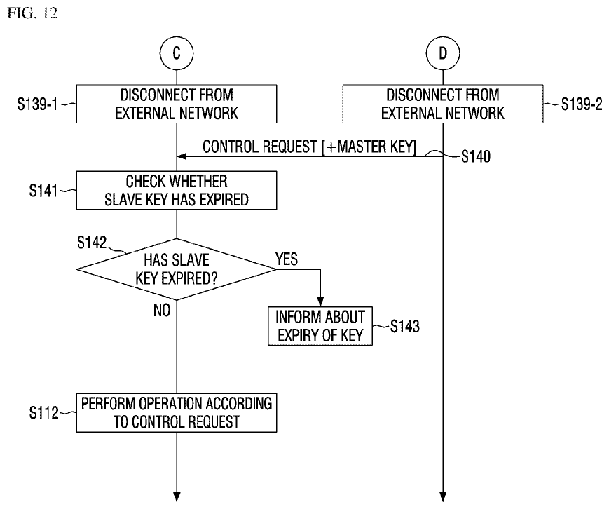

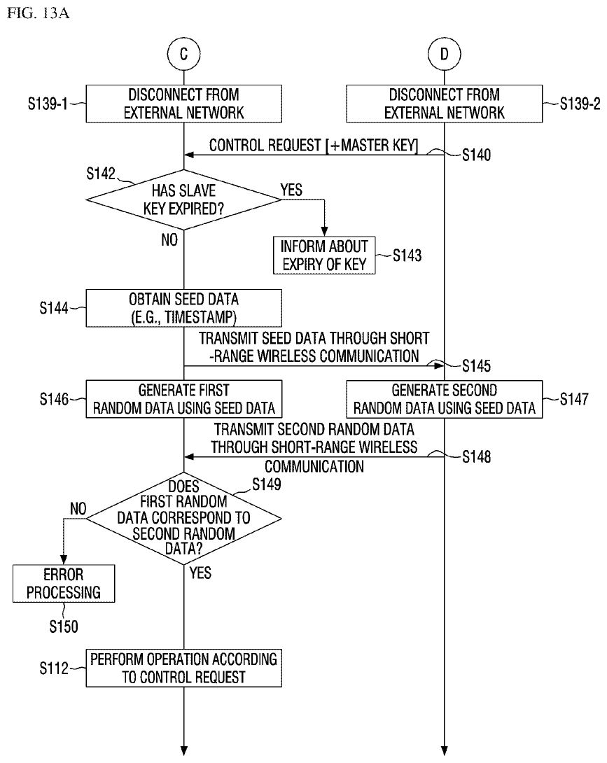

A method of operating a wireless communication device using a slave key will now be described with reference to FIG. 12. As described above, after a slave key and its expiry information are stored in the wireless communication device and the slave key is stored in the slave control terminal, the connection of the wireless communication device to the server through the external network can be interrupted, and the connection of the slave control terminal to the server through the external network can also be interrupted. In FIG. 12, the wireless communication device is disconnected from the external network (operation S139-1), and the slave control terminal is disconnected from the external network (operation S139-2).

When a short-range wireless communication connection is established between the slave control terminal 400 and the wireless communication device 100 and the slave control terminal 400 transmits a control request including a slave key stored in the slave control terminal 400 through the short-range wireless communication connection (operation S140), the wireless communication device 100 determines whether the slave key included in the control request is stored in the wireless communication device 100 or, even if stored, has already expired at the time of referring to expiry information of the slave key (operation S114). The wireless communication device 100 can identify the slave key because the master key and the slave key are different in at least one of length and format. The wireless communication device 100 may check whether the slave key has expired, which is not performed on the master key.

If the key received from the slave control terminal 400 is an expired slave key (operation S142), the wireless communication device 100 may output a message informing that the key is an expired key (operation S143). On the other hand, if the key received from the slave control terminal 400 is a valid slave key (operation S142), the wireless communication device 100 performs an operation according to the control request of the slave control terminal 400 (operation S112).

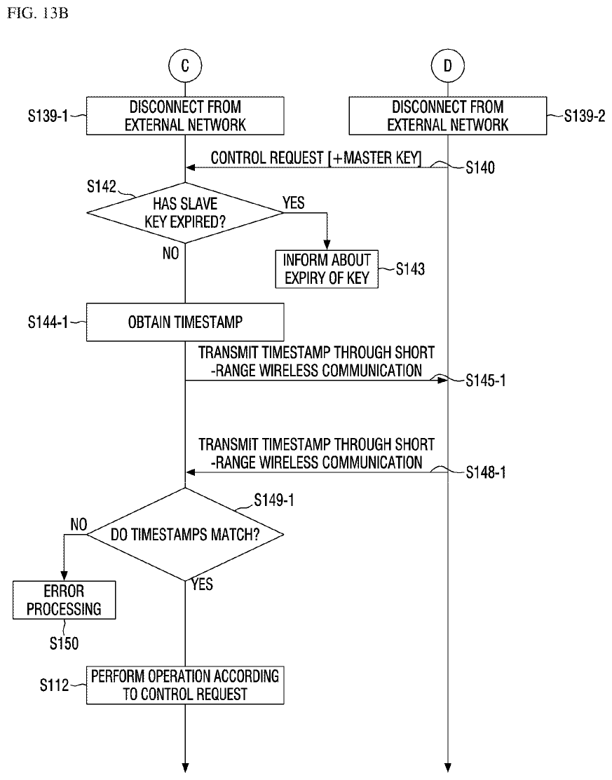

In some embodiments, the security in operating the wireless communication device using the slave key can also be increased by performing additional authentication in the same manner as in operating the wireless communication device using the master key. These embodiments are illustrated in FIGS. 13A and 13B.

FIG. 13A is a diagram for explaining an embodiment related to additional authentication through random data comparison. Referring to FIG. 13, when the slave control terminal 400 transmits a control request including a slave key stored in the slave control terminal 400 through the short-range wireless communication connection (operation S140), the wireless communication device 100 determines whether the slave key included in the control request is stored in the wireless communication device 100 or, even if stored, has already expired at the time of referring to expiry information of the slave key (operation S142). If the key received from the slave control terminal 400 is an expired slave key (operation S142), the wireless communication device 100 may output a message informing that the key is an expired key (operation S143). On the other hand, if the key received from the slave control terminal 400 is a valid slave key (operation S142), the wireless communication device 100 performs additional authentication through random data comparison (operation S144 through S150) and performs an operation according to the control request of the slave control terminal 400 if the additional authentication passes (operation S112).

FIG. 13B is a diagram for explaining an embodiment related to additional authentication using a timestamp. Referring to FIG. 13, when the slave control terminal 400 transmits a control request including a slave key stored in the slave control terminal 400 through the short-range wireless communication connection (operation S140), the wireless communication device 100 determines whether the slave key included in the control request is stored in the wireless communication device 100 or, even if stored, has already expired at the time of referring to expiry information of the slave key (operation S142). If the key received from the slave control terminal 400 is an expired slave key (operation S142), the wireless communication device 100 may output a message informing that the key is an expired key (operation S143).

On the other hand, if the key received from the slave control terminal 400 is a valid slave key (operation S142), the wireless communication device 100 obtains a timestamp at that time (operation S144-1) and transmits the obtained timestamp to the slave control terminal 400 (operation S145-1). When a timestamp is received from the slave control terminal 400 in response to the timestamp (operation S148-1), the wireless communication device 100 verifies whether the obtained timestamp matches the received timestamp (operation S149-1). When the two timestamps match each other, the wireless communication device 100 performs an operation according to the control request of the slave control terminal 400 (operation S112). The wireless communication device 100 may generate a modified slave key using the slave key and the obtained timestamp, transmit the modified slave key to the slave control terminal 400, and determine whether the obtained timestamp is returned from the slave control terminal 400 in order to identify whether a slave key related application installed in the slave control terminal 400 is a fabricated application. This operation is performed because, if fraudulent software for operating the wireless communication device 100 using a slave key leaked by hacking is installed in the slave control terminal 400, the fraudulent software will not be able to interpret the modified slave key.

In some embodiments, the timestamp may be replaced with random data obtained at the time when the slave key authentication passes (operation S142). That is, in the current embodiment, when the slave key authentication passes (operation S142), the wireless communication device 100 may obtain verification data, transmit the obtained verification data to the slave control terminal 400, and additionally authenticate whether the slave control terminal 400 can return the verification data as it is.

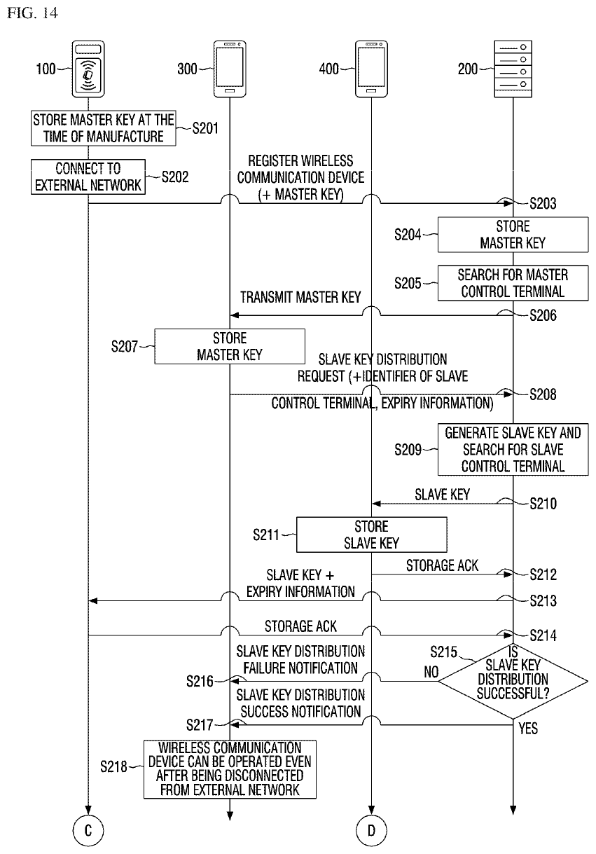

FIG. 14 is a signal flowchart illustrating a method of operating a wireless communication device according to an embodiment of the inventive concept. In the current embodiment, even if a wireless communication device 100, a master control terminal 300, etc. are disconnected from an external network after the wireless communication device 100 is connected to a server 200 through the external network at the time of installing the wireless communication device 100, the wireless communication device 100 can still be operated normally.

A master key is stored at the time of manufacturing the wireless communication device 100 (operation S201), and the wireless communication device 100 is connected to the server 200 as the wireless communication device 100 is installed (operation S202). The wireless communication device 100 registers with the server 200 by transmitting the master key to the server 200 through the external network (operation S203).

The server 200 stores the master key received from the wireless communication device 100 (operation S204). Here, the server 200 prevents the master key from being stored redundantly. The server 200 searches for a master control terminal corresponding to the wireless communication device 100 that corresponds to the master key (operation S205). For example, a user of the master control terminal 300 may join an online service provided by the server 200 and then register the wireless communication device 100 through a product registration function, thereby matching the master control terminal 300 with the wireless communication device 100. The server 200 transmits the master key to the master control terminal 300, and the master control terminal 300 stores the received master key (operation S207).

The master control terminal 300 generates a slave key distribution request using information input by the user to an application and transmits the slave key distribution request to the server 200 (operation S208). The slave key distribution request includes an identifier of a slave control terminal or an ID or phone number of a user of the slave control terminal and expiry information of the slave key.

The server 200 receives the slave key distribution request, generates a slave key to be transmitted to each slave control terminal, and searches for a slave control terminal to which the slave key is to be transmitted (operation S209). The server 200 transmits the generated slave key to a slave control terminal 400 (operation S210). The slave control terminal 400 stores the received slave key (operation S211) and transmits an Ack signal as the storage result (operation S212). In addition, the server 200 transmits the slave key and the expiry information of the slave key to the wireless communication device 100 (operation S213). The wireless communication device 100 stores the slave key and the expiry information of the slave key and transmits an Ack signal as the storage result (operation S214). The server 200 determines whether the slave key has been normally transmitted to the slave control terminal 400 and the wireless communication device 100 (operation S215) and transmits the determination result to the master control terminal 300 (operations S216 and S217) to inform the user of the master control terminal 300 about the slave key distribution result.

Since the master control terminal 300 has already stored the master key received from the server 200 in operation S207, it can operate the wireless communication device 100 without any problem even after being disconnected from the external network. In addition, even after the wireless communication device 100 and the slave control terminal 400 are disconnected from the external network, the wireless communication device 100 can still be operated without any problem as can be understood by referring to a series of operations described with reference to FIGS. 12 and 13.

The methods according to the embodiments of the inventive concept described so far can be performed by the execution of a computer program embodied in computer-readable code. The computer program may be transmitted from a first electronic device to a second electronic device through a network such as the Internet and may be installed and used in the second electronic device. Examples of the first electronic device and the second electronic device include fixed electronic devices such as a server, a physical server belonging to a server pool for a cloud service, and a desktop PC.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A digital door lock comprising:
a storage unit which stores a master key unique to the digital door lock and recorded at the time of manufacturing the digital door lock;
a wireless communication interface which provides a short-range wireless communication function; and
a processor which controls the wireless communication interface to transmit the master key to a master control terminal directly connected through the wireless communication interface,
wherein the processor compares a master key included in a control request with the master key stored in the storage unit when receiving the control request from the master control terminal through the wireless communication interface, obtains verification data and controls the wireless communication interface to transmit the verification data to the master control terminal when determining that authentication has passed as a result of the comparison, and generates a control signal for performing an operation according to the control request when receiving the verification data from the master control terminal through the wireless communication interface.

2. The digital door lock of claim 1, wherein the verification data is a timestamp obtained between a time when it is determined that the authentication has passed as a result of the comparison and a time when the wireless communication interface is controlled to transmit the verification data.

3. The digital door lock of claim 1, wherein the processor checks a value of a flag initialized to a first value at the time of manufacturing the digital door lock, transmits the master key only when the value of the flag is the first value, and changes the value of the flag to a second value different from the first value when transmitting the master key.

4. The digital door lock of claim 1, wherein the processor checks a key issuance counter which is initialized at the time of manufacturing the wireless communication device and is incremented by one upon transmission of the master key and transmits the master key only when the value of the key issuance counter is less than a preset threshold value.

5. The digital door lock of claim 1, wherein the master key is generated using both an identifier of the processor and a manufacturer identifier unique to a manufacturer of the digital door lock.

6. The digital door lock of claim 1, wherein the wireless communication interface is for near-field communication (NFC) wireless communication, and the processor controls the wireless communication interface to transmit the master key in response to NFC tagging through the wireless communication interface.

7. The digital door lock of claim 6, wherein the processor controls the wireless communication interface to transmit the master key in response to the NFC tagging performed in a state where the digital door lock has been initialized.

8. The digital door lock of claim 1, wherein the master control terminal transmits the master key to the digital door lock through the NFC wireless communication by using host card emulation (HCE) technology.

9. The digital door lock of claim 1, wherein the storage unit stores the master key encrypted using white block cryptography (WBC) technology.

10. The digital door lock of claim 1, wherein the master control terminal is a terminal not connected to a server at the time of receiving the master key and at the time of transmitting the control request.

11. The digital door lock of claim 1, further comprising an Internet interface which is connected to the server through the Internet, wherein the storage unit stores a slave key and expiry information of the slave key received from the server through the Internet interface, and the processor, when receiving a control request from a slave control terminal directly connected through the wireless communication interface, determines whether a slave key included in the control request of the slave control terminal is stored in the storage unit and generates a control signal for performing an operation according to the control request of the slave control terminal based on the determination result, wherein the slave control terminal is a terminal not connected to an external network, and the Internet interface is not connected to the server when the control request is received from the slave control terminal.

12. The digital door lock of claim 11, wherein the processor generates first random data if determining that the slave key is stored in the storage unit and generates a control signal for performing the operation according to the control request of the slave control terminal if second random data received from the slave control terminal through the wireless communication interface corresponds to the generated first random data.

13. The digital door lock of claim 11, wherein, if determining that the slave key is stored in the storage unit, the processor determines whether the slave key is valid based on expiry information of the slave key and generates a control signal for performing the operation according to the control request of the slave control terminal based on the determination result.

14. The digital door lock of claim 11, wherein the processor deletes an expired slave key from among slave keys stored in the storage unit based on the expiry information.

15. The digital door lock of claim 11, wherein the slave key and the expiry information of the slave key are transmitted by the server in response to a slave key distribution request received from the master control terminal.

16. A digital door lock comprising:
a storage unit which stores a master key unique to the digital door lock and recorded at the time of manufacturing the digital door lock;
a wireless communication interface which provides a short-range wireless communication function; and
a processor which controls the wireless communication interface to transmit the master key to a master control terminal directly connected through the wireless communication interface,
wherein the processor compares a master key included in a control request with the master key stored in the storage unit when receiving the control request from the master control terminal through the wireless communication interface, generates first random data when determining that authentication has passed as a result of the comparison of the master key included in a control request with the master key stored in the storage unit, compares whether second random data received from the master control terminal through the wireless communication interface matches the generated first random data, and generates a control signal for performing an operation according to the control request when the first random data and the second random data correspond to each other as a result of the comparison of the first random data with the second random data.

17. A method of operating a digital door lock, the method comprising:
establishing a first direct connection between the digital door lock and a master control terminal through short-range wireless communication;
, by using the digital door lock, transmitting a master key, which is unique to the digital door lock and stored at the time of manufacturing the digital door lock, to the master control terminal directly connected to the digital door lock through the first direct connection;
storing the master key by using the master control terminal;
establishing a second direct connection between the digital door lock and the master control terminal through the short-range wireless communication;
transmitting a control request to the digital door lock through the second direct connection by using the master control terminal;
, by using the digital door lock, comparing a master key included in the control request with the master key stored at the time of manufacturing the digital door lock, obtaining verification data when determining that authentication has passed as a result of the comparison, and transmitting the encrypted verification data to the master control terminal through the second direct connection;
, by using the master control terminal, decrypting the received timestamp and transmitting the encrypted verification data to the digital door lock through the second direct connection; and
, by using the digital door lock, decrypting the encrypted verification data received from the master control terminal and performing an operation according to the control request when the decrypted verification data matches the obtained verification data.

18. A digital door lock comprising:
a storage unit which stores a master key unique to the digital door lock and recorded at the time of manufacturing the digital door lock;
a wireless communication interface which provides a short-range wireless communication function;
an Internet interface which is connected to a server through the Internet; and
a processor which controls the Internet interface to transmit the master key to the server through the Internet,
wherein the processor compares a master key included in a control request with the master key stored in the storage unit when receiving the control request from a master control terminal, which receives and stores the master key from the server, through the wireless communication interface, obtains verification data and controls the wireless communication interface to transmit the verification data to the master control terminal when determining that authentication has passed as a result of the comparison, and generates a control signal for performing an operation according to the control request when receiving the verification data from the master control terminal through the wireless communication interface, wherein the wireless communication interface receives the control request in a state where Internet connection through the Internet interface is interrupted.

19. The digital door lock of claim 18, wherein the processor controls the Internet interface to transmit the master key in response to being first connected to the server through the Internet interface.
